(19) United States
(12) Patent Application Publication
(10) Pub. No.: US 2021/0232982 A1
(43) Pub. Date: Jul. 29, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Kengo TOKUCHI, Kanagawa (JP); Nobuyuki YAMAZOE, Kanagawa (JP)

(73) Assignee: FUJI XEROX CO., LTD., Tokyo (JP)

(21) Appl. No.: 16/991,167

(22) Filed: Aug. 12, 2020

(30) Foreign Application Priority Data
Jan. 28, 2020 (JP) 2020-011788

(51) Int. Cl. G06Q 10/02; G06Q 20/10; G06Q 20/40

(52) U.S. Cl. CPC G06Q 10/02; G06Q 20/407; G06Q 20/102

(57) ABSTRACT

An information processing apparatus includes a processor configured to transmit data regarding a record of use of a service used by a user to a different payment system in accordance with a type of account of the user.

### CROSS-REFERENCE TO RELATED APPLICATIONS

This application is based on and claims priority under 35 USC 119 from Japanese Patent Application No. 2020-011788 filed Jan. 28, 2020.

### BACKGROUND

### (i) Technical Field

The present disclosure relates to an information processing apparatus and a non-transitory computer readable medium.

### (ii) Related Art

Systems that make payment for use of a service are known.

In Japanese Unexamined Patent Application Publication No. 2013-89099, a technique for separating payment for use of an application on a device owned by a corporation and payment for use of an application on a device owned by a person using a single payment system.

### SUMMARY

Aspects of non-limiting embodiments of the present disclosure relate to provision of a mechanism capable of making payment according to a type of an account of a user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to transmit data regarding a record of use of a service used by a user to a different payment system in accordance with a type of account of the user.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to an exemplary embodiment;

FIG. 2 is a block diagram illustrating the configuration of an operation management system;

FIG. 3 is a block diagram illustrating the configuration of a reservation management system;

FIG. 4 is a block diagram illustrating the configuration of a terminal apparatus;

FIG. 5 is a flowchart illustrating a process for registering a personal user to the reservation management system;

FIG. 6 is a diagram illustrating a personal user management table;

FIG. 7 is a diagram illustrating a login screen;

FIG. 8 is a diagram illustrating a reservation screen;

FIG. 9 is a diagram illustrating a reservation management table;

FIG. 10 is a flowchart illustrating a process for making payment for a user having a personal account;

FIG. 11 is a flowchart illustrating a process for withdrawing a personal user from the reservation management system;

FIG. 12 is a flowchart illustrating a process for registering a corporate user to the reservation management system;

FIG. 13 is a diagram illustrating a corporate user management table;

FIG. 14 is a diagram illustrating another login screen;

FIG. 15 is a diagram illustrating a service selection screen;

FIG. 16 is a flowchart illustrating a process for making payment for a corporation;

FIG. 17 is a flowchart illustrating a process for withdrawing a corporate user from the operation management system;

FIG. 18 is a diagram illustrating use periods of a booth;

FIG. 19 is a diagram illustrating a withdrawal screen;

FIG. 20 is a diagram illustrating a screen;

FIG. 21 is a diagram illustrating relationships between users belonging to a corporation; and

FIG. 22 is a diagram illustrating another reservation management table.

### DETAILED DESCRIPTION

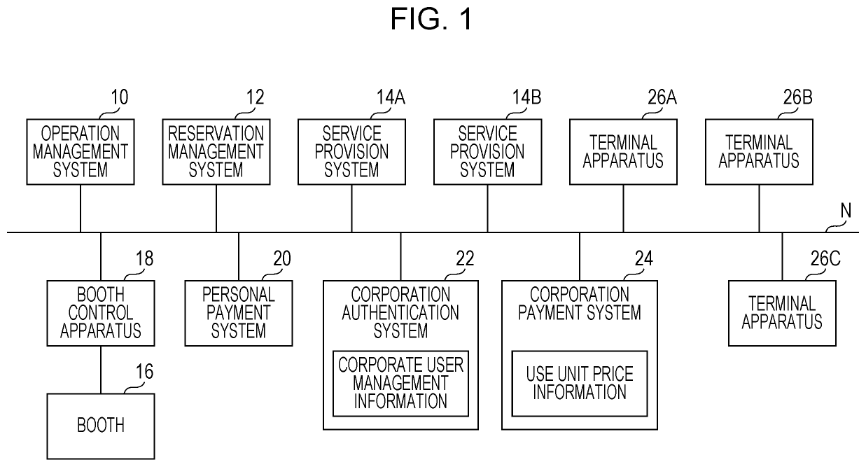

An information processing system according to an exemplary embodiment will be described with reference to FIG. 1. FIG. 1 illustrates an example of the configuration of the information processing system according to the present exemplary embodiment.

The information processing system according to the present exemplary embodiment includes an operation management system 10, a reservation management system 12, which is an example of a service provision system, service provision systems other than the reservation management system 12 (e.g., service provision systems 14A and 14B), a booth control apparatus 18 that controls booths 16, which are an example of use places, a personal payment system 20, a corporation authentication system 22, a corporation payment system 24, and terminal apparatuses (e.g., terminal apparatuses 26A to 26C). The number of systems and apparatuses illustrated in FIG. 1 is just an example.

The systems and the apparatuses included in the information processing system each have a function of communicating with the other systems and apparatuses. The communication may be achieved by wired communication employing cable or wireless communication. That is, the systems and the apparatuses may each be physically connected to the other systems and apparatuses and communicate information with each other or wirelessly communicate information. Short-distance wireless communication or Wi-Fi (registered trademark) may be used for the wireless communication. Another wireless communication standard may be used, instead. Short-distance wireless communication may be, for example, Bluetooth (registered trademark), radio-frequency identification (RFID), near-field communication (NFC), or the like. The systems and the apparatuses, for example, each communicate with the other systems and apparatuses through a communication path N such as local area network (LAN) or the Internet.

In the information processing system according to the present exemplary embodiment, the service provision systems provide services for users. The service provided by the service provision systems is, for example, a service for providing the booths 16 for users, a service for providing places other than the booths 16 (e.g., meeting rooms, shared rooms, shared offices, or other types of space), a service for providing printers, a service for providing virtual desktop infrastructure (VDI), a service for providing remote meetings, a web service, or another service. The web service is, for example, a service for providing applications on a network such as the Internet or another service. Examples of the web service include online learning (e.g., English conversation classes, etc.), web-based training (WBT), webmail, a social networking service (SNS), a service for providing moving images or music on the Internet, a service for selling products or making reservations on the Internet, a search service on the Internet, and a service for providing information on the Internet. It is needless to say that the service provision systems may provide other kinds of service.

When a user's account is created and the user is registered to the information processing system, for example, the user can use available services.

The user's account is, for example, a personal account for an individual person to use services or an organization account for a user belonging to an organization (e.g., a corporation such as a company or another organization) to use services. It is assumed in the following description, for example, that organizations are corporations (e.g., profit-making corporations, nonprofit corporations, etc.) and organization accounts are corporate accounts.

In the following description, users who use services with personal accounts will be referred to as “personal users”, and users who use services with corporate accounts will be referred to as “corporate users”.

Personal users can use services made available using personal accounts. For example, personal users are registered for each service and can use the services for which the personal users have been registered. Corporate users can use services made available using corporate accounts. When a contract to use one or more services is made between a corporation and a management company or the like that provides the operation management system 10, corporate users belonging to the corporation can use the one or more services made available by the contract.

A user might have both a personal account and a corporate account. When a user is registered as a personal user, for example, a personal account is assigned to the user. When the user also belongs to a corporation, a corporate account might be issued and assigned to the user. In this case, the user has both a personal account and a corporate account. The user may use a service using the personal account or the corporate account.

The services provided by the service provision systems are basically paid services, and when a user uses a service, a payment system makes payment for using the service. That is, when a service is used, a fee for using the service is charged, and the payment service performs a charging process (e.g., a payment process). It is needless to say that free services may also be provided, instead.

The operation management system 10 is configured to manage the operation of the information processing system according to the present exemplary embodiment. For example, the operation management system 10 helps the reservation management system 12 and the service provision systems 14A and 14B provide services and controls processes relating to payment. The operation management system 10 is managed, for example, by a management company or the like that provides the information processing system according to the present exemplary embodiment.

The reservation management system 12 is configured to manage reservations for the booths 16. If a user reserves one of the booths 16, for example, the user is permitted to use the reserved booth 16. If a user reserves one of the booths 16 while specifying a use period, in which the booth 16 is made available, for example, the user can use the reserved booth 16 for the use period. A use period is defined, for example, by a date and a time period. The reservation management system 12 may manage reservations for spaces or places other than the booths 16, instead.

The service provision systems 14A and 14B are configured to provide services other than service provided by the reservation management system 12. The service provision systems 14A and 14B may provide different services or the same services. Although the information processing system includes the service provision systems 14A and 14B as service provision systems other than the reservation management system 12 in the example illustrated in FIG. 1, the information processing system may or may not include one or more service provision systems as systems other than the reservation management system 12.

The booths 16 are an example of spaces or places rented by users. Partitioned spaces, private rooms, seats, and sections are examples of the booths 16. The booths 16 rented by users are each provided with a controllable lock. For example, the booths 16 each include a door fitted with an electronic lock. The reservation management system 12 manages reservations for the booths 16.

A lighting device, a power supply, an air conditioner, and other apparatuses (e.g., a multifunction peripheral (MFP) having functions of printing, scanning, and copying) may also be provided in each of the booths 16.

Various sensors may be provided for each of the booths 16. For example, a human detection sensor that detects presence or absence of a person inside a booth 16, a temperature sensor that detects temperature inside a booth 16, a humidity sensor that detects humidity inside a booth 16, an odor sensor that detects odor inside a booth 16, an air pressure sensor that detects air pressure inside a booth 16, a camera that captures an image inside a booth 16, a microphone that collects sound inside a booth 16, and the like may be provided for each of the booths 16.

The booth control apparatus 18 controls the electronic locks provided for the booths 16 and various apparatuses provided inside the booths 16. For example, the booth control apparatus 18 includes a communication device, a user interface (UI), a memory, and a processor. The processor of the booth control apparatus 18, for example, controls the electronic locks and the various apparatuses in the booths 16. The booth control apparatus 18 may control only one booth 16 or plural booths 16. Alternatively, the information processing system may include plural booth control apparatuses 18, and each of the plural booth control apparatuses 18 may control one or more booths 16.

The personal payment system 20 is configured to, when a personal user uses a service using a personal account, make payment for the personal user. That is, the personal payment system 20 processes charging of use fees for personal users. The personal payment system 20 may be a known payment system. For example, a personal payment account, which is an account for making payment for a personal user, is created, and the personal account of the personal user and the personal payment account are associated with each other and managed. When a service is used using a personal account, the personal payment system 20 makes payment using a personal payment account associated with the personal account. Information regarding a credit card owned by the user is registered to the personal payment system 20, for example, and the personal payment system 20 makes payment using the credit card. The personal payment system 20 corresponds to an example of a first payment system.

The corporation authentication system 22 is configured to authenticate a user belonging to a corporation, which is an example of an organization. Sender policy framework (SPF), for example, is used for the authentication. For example, the corporation authentication system 22 stores corporate user management information. Cooperation identification information (e.g., a corporation identifier (ID)) for identifying a corporation and user information regarding users belonging to the corporation (e.g., information including user identification information for identifying users), for example, are registered in corporate user management information and managed for each corporation while being associated with each other.

The corporation payment system 24 is configured to, when a user uses a service using a corporate account, make payment for a corporation having the corporate account. That is, the corporation payment system 24 processes charging of use fees for corporations. The corporation payment system 24 may be a known payment system. For example, use unit price information indicating a unit price of use of a service is created and stored in the corporation payment system 24. The unit price of use may be determined for each corporation. The unit price of use is determined, for example, by a contract. The corporation payment system 24 makes payment for corporations using use unit price information. The corporation payment system 24 is to an example of a second payment system.

The terminal apparatuses 26A to 26C are, for example, personal computers (PCs), tablet PCs, smartphones, or mobile phones.

For example, the terminal apparatus 26A is used by a personal user, the terminal apparatus 26B is used by a user belonging to a corporation, and the terminal apparatus 26C is used by a user who manages users belonging to corporations. The terminal apparatus 26A to 26C will be referred to as “terminal apparatuses 26” hereinafter when the terminal apparatuses 26A to 26C need not be distinguished from one another. A terminal apparatus used by a person who manages the operation management system 10 may also be included in the information processing system.

In the information processing system according to the present exemplary embodiment, data regarding records of use of services by users is transmitted to different payment systems in accordance with types of account of the users, and the payment systems make payments. Records of use include, for example, types of service, the length of use periods of services, use periods, and the number of times of use. The payment systems make payment on the basis of the records of use. For example, data regarding records of use is transmitted to the payment systems at predetermined time intervals (e.g., every fiscal month), and the payment systems make payment.

More specifically, when a user uses a service using a personal account, data regarding records of use of the service by the user is transmitted to the personal payment system 20, and the personal payment system 20 makes payment for the user.

When users belonging to a certain corporation use services using corporate accounts, data regarding records of use of the services by the users is transmitted to the corporation payment system 24, and the corporation payment system 24 makes payment for the corporation. The corporation payment system 24 does not make payment for individual users belonging to corporations.

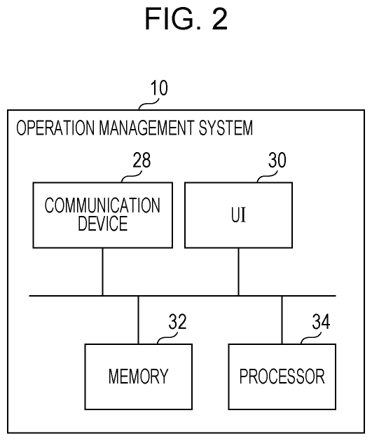

The configuration of the operation management system 10 will be described in detail hereinafter with reference to FIG. 2. FIG. 2 illustrates an example of the configuration of the operation management system 10.

The operation management system 10 includes, for example, a communication device 28, a UI 30, a memory 32, and a processor 34. The operation management system 10 may also include other components.

The communication device 28 is a communication interface and has a function of transmitting data to other apparatuses and a function of receiving data from other apparatuses. The communication device 28 may have a wireless communication function or a wired communication function. For example, the communication device 28 may communicate with other apparatuses through short-distance wireless communication or through the communication path N such as a LAN or the Internet.

The UI 30 includes at least a display device or an operation device. The display device is a liquid crystal display or an electroluminescent (EL) display, or the like. The operation device is a keyboard, input keys, an operation panel, or the like. The UI 30 may be a touch panel that serves as both a display device and an operation device, instead.

The memory 32 achieves one or more storage areas for storing data. The memory 32 is, for example, a hard disk drive, one of various memories (e.g., a random-access memory (RAM), a dynamic RAM (DRAM), or a read-only memory (ROM)), another storage device (e.g., an optical disc), or any selective combination of these. The operation management system 10 includes one or more memories 32.

The processor 34 is configured to control the operation of each component of the operation management system 10. The processor 34 may include a memory.

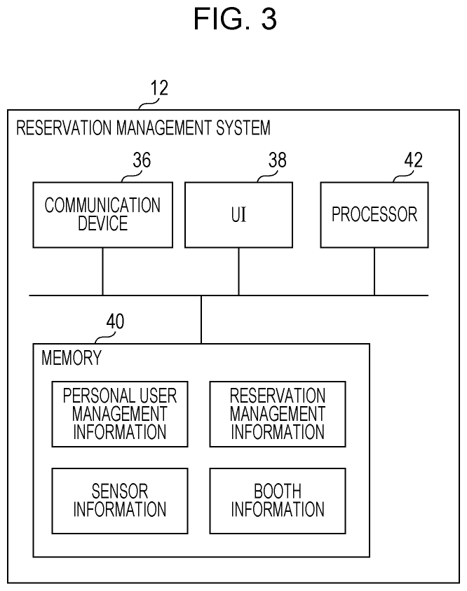

The configuration of the reservation management system 12 will be described in detail hereinafter with reference to FIG. 3. FIG. 3 illustrates an example of the configuration of the reservation management system 12.

The reservation management system 12 includes, for example, a communication device 36, a UI 38, a memory 40, and a processor 42. The reservation management system 12 may also include other components.

The communication device 36 is a communication interface and has a function of transmitting data to other apparatuses and a function of receiving data from other apparatuses. The communication device 36 may have a wireless communication function or a wired communication function. For example, the communication device 36 may communicate with other apparatuses through short-distance wireless communication or through the communication path N such as a LAN or the Internet.

The UI 38 includes at least a display device or an operation device. The display device is a liquid crystal display, an EL display, or the like. The operation device is a keyboard, input keys, an operation panel, or the like. The UI 38 may be a touch panel that serves as both a display device and an operation device, instead.

The memory 40 achieves one or more storage areas for storing data. The memory 40 is, for example, a hard disk drive, one of various memories (e.g., a RAM, a DRAM, or a ROM), another storage device (e.g., an optical disc), or any selective combination of these. The operation management system 10 includes one or more memories 40.

The memory 40 stores, for example, personal user management information, reservation management information, sensor information, and booth information.

The personal user management information is used to manage users registered in the reservation management system 12. For example, accounts of the users registered in the reservation management system 12 are registered in the personal user management information. More specifically, user information and the like regarding the users registered in the reservation management system 12 are registered in the personal user management information. The users registered in the reservation management system 12 can use the service provided by the reservation management system 12. That is, the users registered in the reservation management system 12 can reserve the booths 16 using the reservation management system 12.

The reservation management information is used to manage reservations for the booths 16. For example, booth identification information for identifying the booth 16, use period information indicating use periods (e.g., times of reservations) of the booth 16, user information regarding users who have reserved the booths 16, and use information necessary to use the booth 16 in use periods are registered in the reservation management information.

The sensor information is obtained by the sensors provided for the booth 16. If one of the sensors detects an abnormality, information indicating the detection of the abnormality may be included in the sensor information. For example, sensor information regarding each of the booths 16 is stored in the memory 40.

The booth information indicates use conditions of the booths 16 and the like. For example, whether the booths 16 are being used is managed, and information regarding these use conditions is included in the booth information.

At least the personal user management information, the reservation management information, the sensor information, or the booth information may be stored in the memory 32 of the operation management system 10. In this case, the information stored in the operation management system 10 need not be stored in the reservation management system 12.

The processor 42 is configured to control the operation of each component of the reservation management system 12. The processor 42 may include a memory.

For example, the processor 42 is configured to manage reservations for the booths 16. The processor 42 receives requests to reserve the booths 16 from the terminal apparatuses 26, for example, and registers the reservations for the booths 16 to the reservation management information. The processor 42 permits the users who have reserved the booths 16 to use the corresponding booths 16. If use periods are determined, the processor 42 permits the users to use the corresponding booths 16 for the use periods.

The processor 42 is also configured to transmit data regarding records of use, by users, of service provided by the reservation management system 12 (e.g., data regarding records of use of the booths 16) to different payment systems in accordance with types of account of the users. For example, when a service (e.g., one of the booths 16) provided by the reservation management system 12 is used using a personal account, for example, the processor 42 transmits data regarding a record of the use to the personal payment system 20. When a service (e.g., one of the booths 16) provided by the reservation management system 12 is used using a corporate account, the processor 42 transmits data regarding a record of the use to the corporation payment system 24. As a result, when a service is used using a personal account, the personal payment system 20 makes payment, and when a service is used using a corporate account, the corporation payment system 24 makes payment.

The processor 42 may also be configured to create accounts for using the service provided by the reservation management system 12, register users, and authenticate users.

The processes performed by the processor 42 of the reservation management system 12 may be performed by the processor 34 of the operation management system 10, instead. When a service is used using a corporate account, for example, the processor 34 of the operation management system 10 may transmit data regarding a record of the use to the corporation payment system 24. Similarly, the processor 34 of the operation management system 10 may perform other processes, instead.

The service provision systems 14A and 14B each include, as with the reservation management system 12, a communication device, a UI, a memory, and a processor.

The memory of the service provision system 14A stores personal user management information used to manage users registered in the service provision system 14A. For example, accounts of the users registered in the service provision system 14A are registered in the personal user management information. The users registered in the service provision system 14A can use service provided by the service provision system 14A. The same holds for the service provision system 14B.

When the service provided by the service provision system 14A is reservable, the memory of the service provision system 14A stores reservation management information for managing reservations for the service provided by the service provision system 14A.

The processor of the service provision system 14A is configured to transmit data regarding records of use, by users, of the service provided by the service provision system 14A to different payment systems in accordance with types of account of the users. For example, when a service provided by the service provision system 14A is used using a personal account, the processor 42 of the service provision system 14A transmits data regarding a record of the use to the personal payment system 20. When a service provided by the service provision system 14A is used using a corporate account, the processor 42 of the service provision system 14A transmits data regarding a record of the use to the corporation payment system 24. As a result, when a service is used using a personal account, the personal payment system 20 makes payment, and when a service used using a corporate account, the corporation payment system 24 makes payment. The same holds for the service provision system 14B.

The processor of the service provision system 14A may also be configured to create accounts for using the service provided by the service provision system 14A, register users, and authenticate users. The same holds for the service provision system 14B.

The processes performed by the processors of the service provision systems 14A and 14B may be performed by the processor 34 of the operation management system 10, instead.

The configuration of each of the terminal apparatuses 26 will be described in detail hereinafter with reference to FIG. 4. FIG. 4 illustrates an example of the configuration of each of the terminal apparatuses 26.

The terminal apparatus 26 includes, for example, a communication device 44, a UI 46, a memory 48, and a processor 50.

The communication device 44 is a communication interface and has a function of transmitting data to other apparatuses and a function of receiving data from other apparatuses. The communication device 44 may have a wireless communication function or a wired communication function. For example, the communication device 44 may communicate with other apparatuses through short-distance wireless communication or through the communication path N such as a LAN or the Internet.

The UI 46 includes at least a display device or an operation device. The display device is a liquid crystal display or an EL display. The operation device is a keyboard, input keys, an operation panel, or the like. The UI 46 may be a touch panel that serves as both a display device and an operation device, instead.

The memory 48 achieves one or more storage areas for storing data. The memory 48 is, for example, a hard disk drive, one of various memories (e.g., a RAM, a DRAM, or a ROM), another storage device (e.g., an optical disc), or any selective combination of these. The terminal apparatus 26 includes one or more memories 48.

The processor 50 is configured to control the operation of each component of the terminal apparatus 26. The processor 50 may include a memory.

A case where a user uses the service provided by the reservation management system 12 will be described hereinafter. That is, a case where the user reserves one of the booths 16, the reservation management system 12 manages the reservation, and the user uses the reserved booth 16 will be described.

In the information processing system according to the present exemplary embodiment, an account for using the service (e.g., the booths 16) is created through a different process in accordance with a type of user.

When payment means to be used by a personal user is registered to the personal payment system 20, for example, the processor 42 of the reservation management system 12 creates a personal account for making the booth 16 available to the personal user. When a user belonging to a corporation receives a notification about user registration and information regarding the user is registered, on the other hand, the processor 42 creates a corporate account for enabling the user to use the booths 16. These processes may be performed by the processor 34 of the operation management system 10, instead. These processes will be described in detail hereinafter.

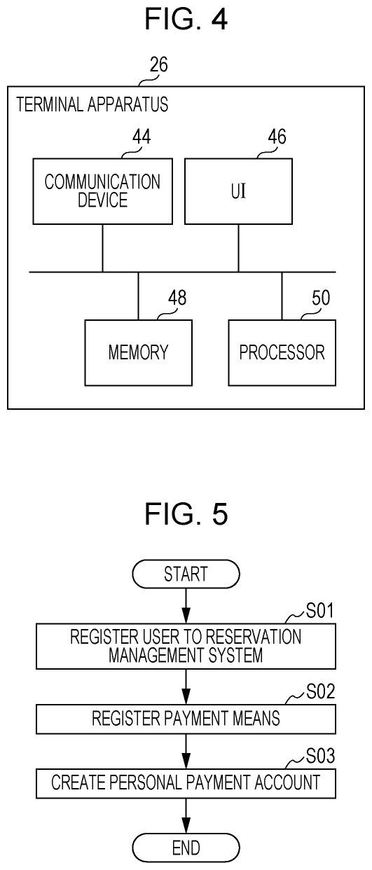

A process for registering a personal user to the reservation management system 12 will be described with reference to FIG. 5. FIG. 5 is a flowchart illustrating the process. A case where a personal user is registered to the reservation management system 12 is an example of a case where a personal user makes a contract to use the service provided by the reservation management system 12.

First, the processor 42 of the reservation management system 12 receives a request to register a personal user and registers the personal user to the reservation management system 12 (S01). For example, a user accesses the reservation management system 12 using the terminal apparatus 26A and requests the reservation management system 12 to register a personal user. As a result, the UI 46 of the terminal apparatus 26A displays a screen for registering the user to the reservation management system 12 as a personal user. The user inputs information such as a name thereof, an email address thereof, and a password on the screen using the terminal apparatus 26A, and the terminal apparatus 26A transmits the information to the reservation management system 12. The processor 42 of the reservation management system 12 registers the information to the personal user management information, creates a personal account, and issues the personal account to the user. For example, the processor 42 creates a user ID associated with the personal account, registers the user ID to the personal user management information, and transmits the user ID to the terminal apparatus 26A. As a result, the user is notified of the user ID. Alternatively, the user ID may be determined by the user, input to the reservation management system 12, and registered in the personal user management information. The user ID and the password associated with the personal account are used by the user to log in to the reservation management system 12 using the personal account.

When payment means has not been registered, the user can log in to the reservation management system 12 using the personal account but is not enabled to reserve the booths 16. That is, the processor 42 of the reservation management system 12 does not permit the user to reserve the booths 16.

Next, the processor 42 of the reservation management system 12 registers payment means for using the booths 16 to the reservation management system 12 and the personal payment system 20 (S02). When the user is registered to the reservation management system 12 and a personal account is created, for example, a screen for registering payment means or a menu for displaying the screen is displayed on the UI 46 of the terminal apparatus 26A. The user inputs information regarding payment means on the screen using the terminal apparatus 26A. When a credit card is used as the payment means, for example, the user inputs information regarding the credit card (e.g., a name of an owner of the credit card, a number, an expiration date, and a security code). The information regarding the credit card is an example of information regarding payment means. The information regarding the credit card is transmitted from the terminal apparatus 26A to the reservation management system 12. The processor 42 of the reservation management system 12 registers the information regarding the credit card to the personal user registration information while associating the information with the personal account. The information regarding the credit card is also transmitted to the personal payment system 20 and registered to the personal payment system 20.

Upon registering the information regarding the credit card, the personal payment system 20 creates a personal payment account (S03).

Information regarding the personal payment account is transmitted from the personal payment system 20 to the reservation management system 12. The processor 42 of the reservation management system 12 registers the personal account and the personal payment account to the personal user management information while associating the personal account and the personal payment account with each other.

After the information regarding the credit card is registered to the personal payment system 20, the personal user can reserve the booths 16. That is, the processor 42 of the reservation management system 12 permits the personal user to reserve the booths 16.

Names of personal users, email addresses, passwords, and information regarding credit cards may be stored in and managed by the operation management system 10, instead.

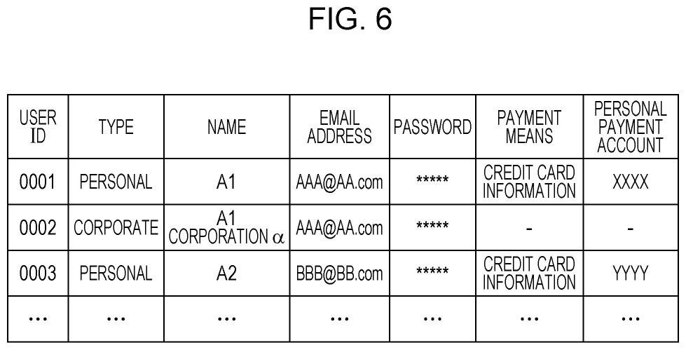

The personal user management information will be described in detail hereinafter with reference to FIG. 6. FIG. 6 illustrates an example of a personal user management table, which is an example of the personal user management information. Data on the personal user management table is stored in the memory 40 of the reservation management system 12.

On the personal user management table, for example, a user ID, information indicating a type of user, information indicating a name of a user, information indicating an email address of a user, a password, information indicating payment means, and a personal payment account are associated with one another for each user.

A type of user is a personal user or a corporate user. A user registered through the steps described with reference to FIG. 5 is registered to the personal user management table as a personal user.

As described above, a personal user is requested to input information regarding a credit card, which is an example of payment means, and the input information regarding a credit card is registered in the personal user management table as information indicating payment means.

In addition, a personal payment account for making payment with the personal payment system 20 is created for a personal user and registered in the personal user management table.

As described later, a user registered as a corporate user is not requested to input information regarding a credit card, which is an example of payment means, and information regarding a credit card is not registered in the personal user management table for a user registered as a corporate user. In addition, a personal payment account is not created, and a personal payment account is not associated with a corporate user.

For example, accounts including user IDs “0001” and “0003” are personal accounts, and a user A1 corresponding to the user ID “0001” and a user A2 corresponding to the user ID “0003” are registered in the personal user management table as personal users. When the user A1 is registered to the reservation management system 12 through the steps described with reference to FIG. 5, for example, a personal account including the user ID “0001” and a personal payment account are created and registered to the personal user management table as information associated with the user ID “0001”. The same holds for the user A2 corresponding to the user ID “0003”.

As described later, accounts of individual users belonging to corporations are registered to the personal user management table as corporate accounts. For example, the user A1 is also registered in the personal user management table as a user belonging to a corporate a. An account including an user ID “0002” is a corporate account associated with the user A1. Creation and registration of a corporate account will be described in detail later. The same email address may be registered for a personal account and a corporate account of a single user, or registration of the same mail address may be inhibited.

Personal user management tables are also created for the service provision systems 14A and 14B and stored in the service provision systems 14A and 14B, respectively.

Data on the personal user management tables may be stored in the memory 32 of the operation management system 10, and the operation management system 10 may manage information registered in the personal user management tables.

As described above, after a personal account and a personal payment account are created for a personal user and registered to the personal user management table, the personal user can reserve the booths 16.

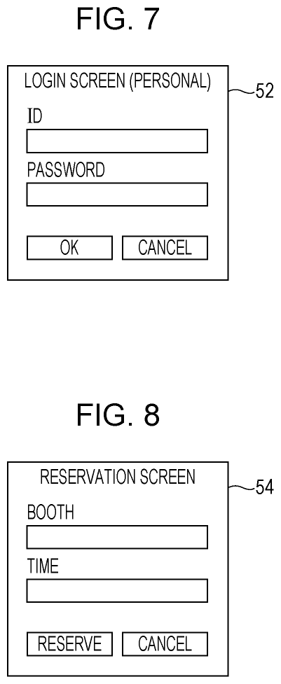

When a personal user accesses the reservation management system 12 using the terminal apparatus 26A, for example, a login screen 52 is displayed on the UI 46 of the terminal apparatus 26A as illustrated in FIG. 7. The login screen 52 includes a field for inputting information (e.g., a user ID and a password) for logging in to the reservation management system 12 using a personal account. When the user inputs a user ID and a password on the login screen 52, the terminal apparatus 26A transmits the input user ID and password to the reservation management system 12. If the input user ID and password are registered in the personal user management table, the processor 42 of the reservation management system 12 permits the user to log in. If the input user ID and password are not registered in the personal user management table, the processor 42 of the reservation management system 12 does not permit the user to log in.

If login to the reservation management system 12 is permitted, the UI 46 of the terminal apparatus 26A displays a reservation screen 54 as illustrated in FIG. 8. The reservation screen 54 is a screen for reserving the booths 16. The user can find places where the booths 16 are installed, reservable booths 16, and reservable use periods on the reservation screen 54. A list of reservable booths 16 or a list of reservable use periods may also be displayed. The user reserves one of the booths 16 by specifying the booth 16 and a use period, and the terminal apparatus 26A transmits information indicating the specified booth 16 and use period to the reservation management system 12. The processor 42 of the reservation management system 12 registers the booth 16 and the use period specified by the user to the reservation management information. The reservation of a booth 16 is thus completed.

The processor 42 of the reservation management system 12 also creates use information, which is necessary to use the booth 16 in the use period, registers the use information to the reservation management information while associating the use information with the reserved booth 16 and use period, and transmits the use information to the terminal apparatus 26A, which has been used for the reservation. The use information may be displayed on the UI 46 of the terminal apparatus 26A or stored in the memory 48 of the terminal apparatus 26A. The use information is, for example, information including a password and key information. For example, the processor 42 of the reservation management system 12 creates different use information for different reservations. The user who uses the terminal apparatus 26A can use the booths 16 using the use information. When a booth 16 is locked, for example, use information is used to unlock the booth 16. In addition, use information may be used to indicate that a booth 16 is being legitimately used. When the booths 16 are seats or vehicles, for example, use information may be used to indicate that the seats or the vehicles are being legitimately used. When the booths 16 are open spaces or places, or when no operation is necessary to use the booths 16, use information need not be used.

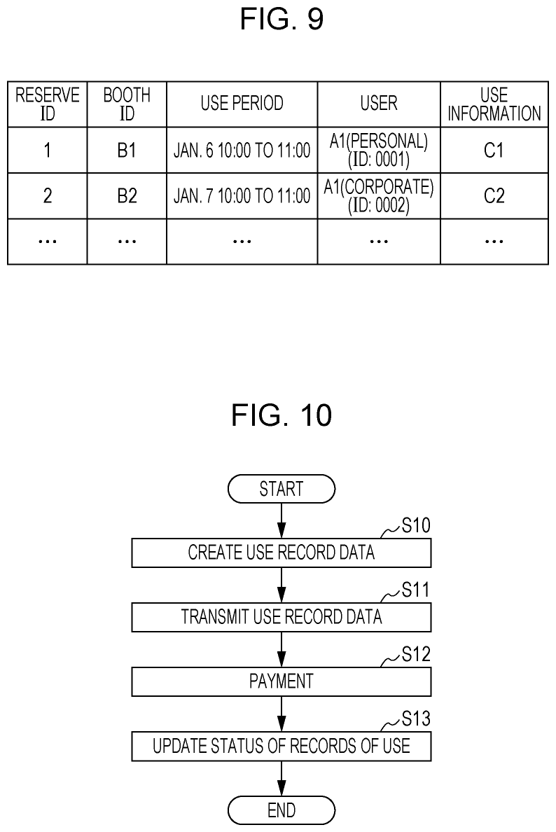

The reservation management information will be described in detail hereinafter with reference to FIG. 9. FIG. 9 illustrates an example of a reservation management table, which is an example of the reservation management information. Data on the reservation management table is stored in the memory 40 of the reservation management system 12.

On the reservation management table, for example, a reservation ID, a booth ID, information indicating a use period, information regarding a user, and use information are associated with one another for each reservation for a booth 16.

A booth ID is an example of information for identifying a reserved booth 16. A booth ID is determined for each booth 16 and associated with the booth 16 in advance.

A use period is a period in which a reserved booth 16 is used. A use period is specified, for example, when a user reserves a booth 16.

Information regarding a user includes user identification information for identifying a user who has reserved a booth 16 and terminal identification information for identifying a terminal apparatus 26 used by a user. User identification information includes, for example, information indicating a name of a user, a user ID, information indicating a type of account of a user, and an email address. Terminal identification information is, for example, address information (e.g., an Internet protocol (IP) address or a media access control (MAC) address) regarding a terminal apparatus 26, a serial number of a terminal apparatus 26, or the like. For example, when a user reserves a booth 16, information regarding the user is transmitted from a terminal apparatus 26 used for the reservation to the reservation management system 12 and registered to the reservation management table.

The reservation management table will be described with reference to a specific example. The user A1 having the personal account including the user ID “0001” has reserved a booth 16 corresponding to a booth ID “B1”. A use period is 10:00 to 11:00 on January 6. Use information C1 is defined as information for using the booth 16 on January 6 from 10:00 to 11:00. The use information C1 is transmitted from the reservation management system 12 to a terminal apparatus 26 used for the reservation.

The user A1 is also registered as a user belonging to a corporation. The user A1 who has a corporate account including the user ID “0002” has reserved a booth 16 corresponding to a booth ID “B2”. A use period is 10:00 to 11:00 on January 7. Use information C2 is defined as information for using the booth 16 on January 7 from 10:00 to 11:00. The reservation management system 12 transmits the use information C2 to a terminal apparatus 26 used for the reservation.

A process performed when the user uses one of the booths 16 will be described hereinafter. It is assumed here that the user A1 having a personal account uses the booth 16 corresponding to the booth ID “B1”. The booth 16 corresponding to the booth ID “B1” will be referred to as a “booth B1” hereinafter for convenience of description.

When the user A1 performs an operation for using the booth B1, the processor 42 of the reservation management system 12 performs an authentication process in order to check whether use of the booth B1 by the user A1 is permitted.

For example, a door of the booth B1 is locked by an electronic lock. The door is provided with a wireless communication device that performs short-distance wireless communication. When the user A1 holds the terminal apparatus 26A onto the door, the terminal apparatus 26A transmits use information to the wireless communication device through short-distance wireless communication. As described above, the use information has been transmitted from the reservation management system 12 to the terminal apparatus 26A and stored in the memory 48 of the terminal apparatus 26A when the user A1 has reserved the booth B1. Upon receiving the use information from the terminal apparatus 26A, the wireless communication device transmits the use information and the booth ID of the booth B1 to the reservation management system 12 through or not through the booth control apparatus 18. The processor 42 of the reservation management system 12 refers to the reservation management table illustrated in FIG. 9 and checks whether use information (e.g., use information C1) associated with the transmitted booth ID and a use period including present time and the transmitted use information match.

If the transmitted use information and the use information C1 match, the processor 42 of the reservation management system 12 permits the user A1 having a personal account to use the booth B1. In this case, the processor 42 of the reservation management system 12 transmits information indicating an instruction to unlock the door to the wireless communication device provided for the door of the booth B1 through or not through the booth control apparatus 18. The electronic lock is opened in accordance with the instruction to unlock the door. After the electronic lock is opened, the user A1 can open the door and enter the booth B1. The processor 42 of the reservation management system 12 also transmits, to the booth control apparatus 18, information indicating a use period for which the booth B1 can be used using the use information C1. The memory of the booth control apparatus 18 stores the information indicating the use period.

If the transmitted use information and the use information C1 do not match, the processor 42 of the reservation management system 12 does not permit the user A1 to use the booth B1. In this case, the processor 42 of the reservation management system 12 does not transmit information indicating an instruction to unlock the door. The electronic lock on the door of the booth B1, therefore, is not opened.

If the present time is between 10:00 and 11:00 on January 6 and the use information transmitted to the reservation management system 12 and the use information C1 match, for example, the processor 42 of the reservation management system 12 permits the user A1 to use the booth B1. If the present time is between 10:00 and 11:00 on January 6 but the transmitted use information and the use information C1 do not match, the processor 42 of the reservation management system 12 does not permit the user A1 to use the booth B1. If the transmitted use information and the use information C1 match but the present time is not between 10:00 and 11:00 on January 6, the processor 42 of the reservation management system 12 does not permit the user A1 to use the booth B1.

Alternatively, the terminal apparatus 26A may transmit a user ID, a booth ID, and use information to the reservation management system 12. In this case, the processor 42 of the reservation management system 12 checks whether a combination of the transmitted user ID and use information and a combination of a user ID associated with use information C1 and the use information C1 match. If the combinations match, the processor 42 permits the user A1 to use the booth B1, and if the combinations do not match, the processor 42 does not permit the user A1 to use the booth B1.

When an end (e.g., 11:00) of the use period comes, for example, the booth control apparatus 18 transmits information indicating that the use period has ended to the terminal apparatus 26A used by the user A1. The information indicating that the use period has ended is displayed on the UI 46 of the terminal apparatus 26A. Alternatively, the information indicating that the use period has ended may be displayed on a display device provided for the booth B1.

When the end (e.g., 11:00) of the use period comes and the user A1 leaves the booth B1, the electronic lock on the door of the booth B1 is set. After the end of the use period comes, the user A1 can no longer open the electronic lock using the use information C1.

When a booth 16 is used using a personal account, a fee for using the booth 16 is charged to a user having the personal account. In the above example, the fee for using the booth B1 is charged to the user corresponding to the user ID “0001”. The personal payment system 20 makes payment for users having personal accounts.

Payment for a user having a personal account will be described in detail hereinafter with reference to FIG. 10. FIG. 10 is a flowchart illustrating a process for making payment for a user having a personal account.

The processor 42 of the reservation management system 12 refers to the reservation management table and creates, for each user who has a personal account, use record data, which indicates records of use of the booths 16 (S10). In a specific example, the processor 42 of the reservation management system 12 creates use record data, which indicates records of use by the user A1, who is a personal user. The same holds true for other personal users.

For example, the processor 42 of the reservation management system 12 creates use record data for each fiscal month. The use record data includes payment data. The payment data is created on the basis of use fees of the booths 16. A use fee may be determined, for example, for each booth 16, in accordance with the length of a use period, or in accordance with a use condition of equipment provided for the booths 16. Even when a booth 16 is not actually used in a reserved use period, a user who has reserved the booth 16 is charged unless the user cancels the reservation for the booth 16. In addition, a repayment process or a discount process may be performed, and payment data that reflects such a process may be created. For example, a manager of the operation management system 10 or the like may perform a repayment process in response to a claim from a user or a discount process based on a sales campaign or the like.

Next, the processor 42 of the reservation management system 12 transmits the use record data regarding each personal user to the personal payment system 20 (S11). The use record data may be transmitted to the personal payment system 20 if the manager of the operation management system 10 or the like requests transmission of the use record data. A UI 46 of a terminal apparatus 26 used by the manager of the operation management system 10 or the like may display records of use.

Next, the personal payment system 20 makes payment on the basis of the use record data for each personal user (S12). For example, the personal payment system 20 makes payment using a registered credit card.

After the payment is completed, the personal payment system 20 transmits data regarding a result of the payment to the reservation management system 12. Upon receiving the result of the payment, the processor 42 of the reservation management system 12 updates a status of the records of use of each personal user (S13). For example, the processor 42 associates, on the personal user management table, information indicating that the payment has been completed with the user for whom the payment has been completed.

After making the payment, the personal payment system 20 may perform a deposit process for the manager of the operation management system 10 or the like.

As described above, when a user uses a booth 16 using a personal account, the personal payment system 20 makes payment.

Similarly, when a user uses a service provided by the service provision system 14A or 14B, the personal payment system 20 makes payment. That is, the processor of the service provision system 14A transmits use record data regarding each personal user to the personal payment system 20. The use record data indicates records of use of the service provided by the service provision system 14A. The same holds for the service provision system 14B. The personal payment system 20 individually makes payment for each of services used by personal users. That is, the personal payment system 20 individually makes payment for use of the booths 16 provided by the reservation management system 12, payment for use of the service provided by the service provision system 14A, and use of the service provided by the service provision system 14B.

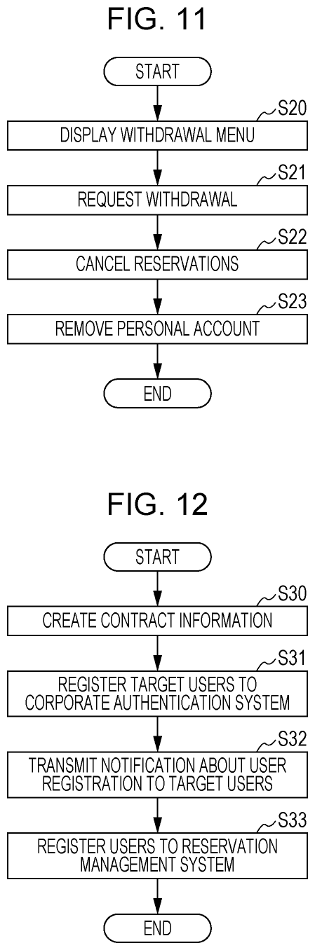

A process for withdrawing a personal user from the reservation management system 12 will be described hereinafter with reference to FIG. 11. FIG. 11 is a flowchart illustrating the process. A case where a personal user withdraws from the reservation management system 12 is an example of a case where a personal user terminates a contract to use the service provided by the reservation management system 12.

First, a user accesses the reservation management system 12 using the terminal apparatus 26A and logs in the reservation management system 12 using a personal account thereof. As a result, the UI 46 of the terminal apparatus 26A displays a menu screen including a withdrawal menu. If a user logs in the reservation management system 12 using a corporate account, the menu screen does not include a withdrawal menu. That is, the menu screen including the withdrawal menu is displayed only when a user logs in the reservation management system 12 using a personal account thereof (S20).

When the user requests withdrawal from the reservation management system 12 using the terminal apparatus 26A (S21), the terminal apparatus 26A transmits information indicating the request to the reservation management system 12.

Upon receiving the request, the processor 42 of the reservation management system 12 cancels all reservations for the booths 16 associated with the withdrawing user (S22). If the user A logs in the reservation management system 12 using the user ID “0001” of the personal account and requests withdrawal from the reservation management system 12, for example, the processor 42 of the reservation management system 12 cancels all reservations registered in the reservation management table and associated with the user ID “0001”. At this stage, the processor 42 of the reservation management system 12 does not remove the personal account including the user ID “0001” from the personal user management table.

Next, the processor 42 of the reservation management system 12 removes, from the personal user management table, a personal account and a personal payment account of a user who has given a request of withdrawal and for whom a predetermined period of time has elapsed since the request was given (S23). For example, when making payment (e.g., every fiscal month), the processor 42 checks a user who has given a request of withdrawal and for whom the predetermined period of time (e.g., 2 months) has elapsed since the request was given, and removes a personal account and a personal payment account of the user from the personal user management table. The processor 42 also transmits an instruction to remove the personal payment account to the personal payment system 20. The personal payment system 20 removes, in accordance with the instruction, the personal payment account registered in the personal payment system 20.

There is a case where a user is reregistered to the reservation management system 12 as a personal user before a personal account thereof is removed after a request of withdrawal is given (i.e., from step S21 to step S23). In this case, a new personal payment account (i.e., a personal payment account different from an already registered personal payment account) is created and registered to the reservation management system 12 and the personal payment system 20. Information regarding a credit card associated with the already registered personal payment account may be used as information regarding a credit card associated with the new personal payment account.

A process for registering a corporate user to the reservation management system 12 will be described hereinafter with reference to FIG. 12. FIG. 12 is a flowchart illustrating the process. A case where a corporate user is registered to the reservation management system 12 is an example of a case where a corporate user makes a contract to use the service provided by the reservation management system 12.

First, a contract is made between a corporation and the management company of the operation management system 10 or the like, contract information is created, and services available to users belonging to the corporation are determined (S30). It is assumed, for example, that each user belonging to a corporation α can use the booths 16 provided by the reservation management system 12 and the service provided by the service provision system 14A in accordance with the contract.

Next, the manager of the operation management system 10 registers, to the corporation authentication system 22 using the terminal apparatus 26C, target users belonging to the corporation a and authorized to use the booths 16 provided by the reservation management system 12 (i.e., users who can use the booths 16) and target users belonging to the corporation α and authorized to use the service provided by the service provision system 14A (i.e., users who can use the service) (S31). For example, a manager screen is displayed on the UI 46 of the terminal apparatus 26C, and the manager registers the target users to the corporation authentication system 22 on the manager screen. For example, the manager specifies corporation identification information for identifying the corporation a, user information regarding the target users, and information for identifying the services available to the target users. The processor 34 of the operation management system 10 registers these pieces of information to the corporate user management information stored in the corporation authentication system 22. The processor 42 of the reservation management system 12 may register the corporate identification information and the user information (e.g., user identification information or email addresses) regarding the target users who can use the booths 16 to the corporate user management information stored in the corporation authentication system 22. Similarly, the processor of the service provision system 14A may register the corporation identification information and the user information regarding the target users who can use the service provided by the service provision system 14A to the corporate user management information stored in the corporation authentication system 22.

Next, a notification about user registration is transmitted to the target users (S32). For example, the processor 34 of the operation management system 10 transmits, to the target users, the notification about user registration to the services available to the target users as an email or the like. For example, the processor 34 of the operation management system 10 transmits, to the target users authorized to use the booths 16, the notification about user registration to the reservation management system 12 and, to the target users to be authorized to use the service provided by the service provision system 14A, the notification about user registration to the service provision system 14A. Alternatively, the processor 42 of the reservation management system 12 may transmit, to the target users authorized to use the booths 16, the notification about user registration to the reservation management system 12, and the processor of the service provision system 14A may transmit, to the target users authorized to use the service provided by the service provision system 14A, the notification about user registration to the service provision system 14A.

Upon receiving the notification about user registration, the target users register themselves to the services available thereto (S33). The user registration to the reservation management system 12 will be described hereinafter.

Each of the target users accesses the reservation management system 12 using the terminal apparatus 26B and requests the reservation management system 12 to register a corporate user. As a result, the UI 46 of the terminal apparatus 26B displays a screen for registering the user to the reservation management system 12 as a corporate user. The target user inputs information such as a name and an email address thereof and a password on the screen using the terminal apparatus 26B, and the terminal apparatus 26B transmits the information to the reservation management system 12. The processor 42 of the reservation management system 12 registers the information to the personal user management information, creates a corporate account, and issues the corporate account to the target user. For example, the processor 42 creates a user ID associated with the corporate account, registers the user ID in the personal user management information, and transmits the user ID to the terminal apparatus 26B. As a result, the user is notified of the user ID. Alternatively, the user ID may be determined by the user, input to the reservation management system 12, and registered to the personal user management information. The user ID and the password associated with the corporate account are used by the user to log in to the operation management system 10 and the reservation management system 12 using the corporate account. For example, the user ID and the password are transmitted to the corporation authentication system 22 and registered to the corporate user management information. Alternatively, the user ID and the password may be stored in the operation management system 10.

For example, the processor 42 of the reservation management system 12 checks whether the user who requests the reservation management system 12 to register a corporate user is registered in the corporate user management information as a target user authorized to use the service provided by the reservation management system 12. For example, the processor 42 may refer to the corporate user management information or inquire the corporation authentication system 22 about the registration. If the user who has requested the reservation management system 12 to register a corporate user is registered in the corporate user management information as a target user authorized to use the service provided by the reservation management system 12, the processor 42 registers the user as a corporate user. If the user who has requested the reservation management system 12 to register a corporate user is not registered in the corporate user management information as a target user authorized to use the service provided by the reservation management system 12, the processor 42 does not register the user as a corporate user.

As described above, after a target user is registered to the reservation management system 12 as a corporate user and a corporate account is issued, the target user can log in to the operation management system 10 and the reservation management system 12 using the corporate account and reserve the booths 16. That is, the processor 42 of the reservation management system 12 permits corporate users to reserve the booths 16. The same holds for the service provision system 14A.

Alternatively, names and email addresses of corporate users, passwords, and the like may be stored in and managed by the operation management system 10.

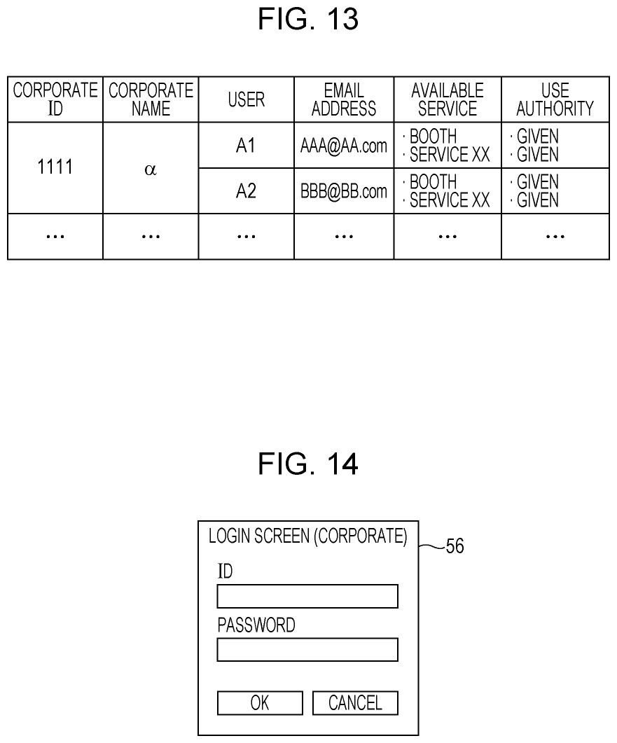

Now, the corporate user management information will be described in detail with reference to FIG. 13. FIG. 13 illustrates an example of a corporate user management table, which is an example of the corporate user management information. Data regarding the corporate user management table is stored in the corporation authentication system 22.

On the corporate user management table, for example, a corporate ID, information indicating a name of a corporation, information indicating names of users belonging to a corporation, information indicating email addresses of users, information indicating services available to users, and information indicating presence or absence of use authority given to users are associated with one another for each corporation. A user ID and a password of each user are also registered in the corporate user management table.

The users A1 and A2, for example, are registered as corporate users belonging to the corporation α. The users A1 and A2 are authorized to use the booths 16 provided by the reservation management system 12 and the service provided by the service provision system 14A.

The user A1 is also registered in the reservation management system 12 as a corporate user. As illustrated in FIG. 6, for example, the user A1 is also registered in the personal user management table as a corporate user and given the user ID “0002”. The same holds for the user A2. Since corporate users are not charged, payment means and personal payment accounts are not associated with corporate users.

For example, the user A1 can log in to the reservation management system 12 as a corporate user using the user ID “0002” and a password associated with the user ID and reserve a booth 16. A reservation method used is the same as the method used by a personal user to reserve a booth 16. As illustrated in FIG. 9, for example, the booth 16 having the booth ID “B2” is reserved by the user A1, who is a corporate user. The user A1 can open the electronic lock on the door of the booth 16 using the use information C2 and use the booth 16 as a corporate user on January 7 from 10:00 to 11:00.

The user A1 is also registered in the personal user management table as a personal user. The user A1, therefore, may reserve a booth 16 using a personal account or a corporate account. If a booth 16 is reserved and used using a personal account, the user A1 is charged by the personal payment system 20. If a booth 16 is reserved and used using a corporate account, the user A1 is not charged, and the corporation payment system 24 charges the corporation α, to which the user A1 belongs.

When a corporate user accesses the operation management system 10 using the terminal apparatus 26B, for example, a login screen 56 is displayed on the UI 46 of the terminal apparatus 26B as illustrated in FIG. 14. A field for inputting information (e.g., a user ID and a password) for logging in to the operation management system 10 using a corporate account is displayed in the login screen 56. The user inputs a user ID and a password on the login screen 56, and the terminal apparatus 26B transmits the input user ID and password to the corporation authentication system 22 through or not through the operation management system 10. The corporation authentication system 22 authenticates the user who has requested login and, if the authentication is successfully completed, permits the user to log in to the operation management system 10 and, if the authentication fails, does not permit the user to log in to the operation management system 10. For example, if the input user ID and password are registered in the corporate user management table, the corporation authentication system 22 permits the user to log in to the operation management system 10 and if the input user ID and password are not registered in the corporate user management table, the corporation authentication system 22 does not permit the user to log in to the operation management system 10. Alternatively, the operation management system 10 may determine whether to permit the user to log therein.

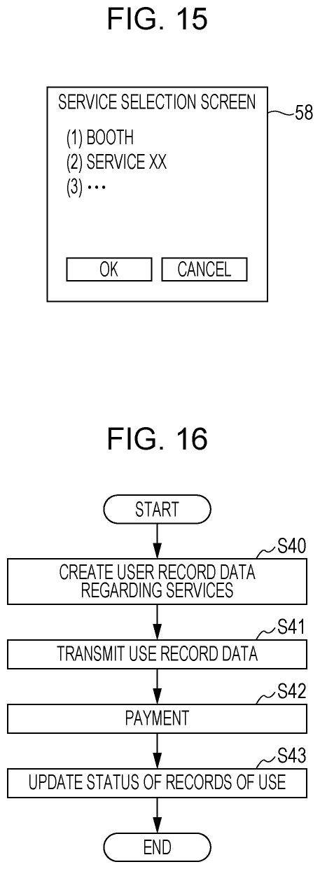

If login to the operation management system 10 is permitted, the UI 46 of the terminal apparatus 26B displays a service selection screen 58 as illustrated in FIG. 15. The service selection screen 58 includes a list of services available to the user A1, who has logged in to the operation management system 10. For example, the processor 34 of the operation management system 10 refers to the corporate user management table and identifies services available to the user A1 and then displays a list of the identified services in the service selection screen 58.

When the user A1 selects a service on the service selection screen 58, a screen for reserving the selected service is displayed on the UI 46 of the terminal apparatus 26B. When a booth 16 is selected, for example, the reservation screen 54 illustrated in FIG. 8 is displayed on the UI 46 of the terminal apparatus 26B. The user A1 can reserve a booth 16 on the reservation screen 54.

As illustrated in FIG. 9, for example, the user A1, who is a corporate user having the corporate account including the user ID “0002”, reserves the booth 16 having the booth ID “B2”. A use period is 10:00 to 11:00 on January 7. Use information C2 is defined as information for using the booth 16 on January 7 from 10:00 to 11:00. The use information C2 is transmitted from the reservation management system 12 to the terminal apparatus 26B used for the reservation.

A process performed when the user A1, who is a corporate user, uses the booth 16 is the same as the process performed when a personal user uses a booth 16, but a payment method is different. When a booth 16 is used using a corporate account, a fee for using the booth 16 is charged to the corporation α to which the user A1 having the corporate account belongs. The corporation payment system 24 makes payment for corporations.

Payment for a corporation will be described in detail hereinafter with reference to FIG. 16. FIG. 16 is a flowchart illustrating a process for making payment for a corporation.

The processor of each service provision system creates, for each corporation, use record data indicating records of use of the service provided by the service provision system (S40). For example, the processor 42 of the reservation management system 12 refers to the reservation management table and creates, for each corporation, use record data indicating records of use of the booths 16. In a specific example, the processor 42 of the reservation management system 12 creates use record data indicating records of use by all users belonging to the corporation α. The same holds for other corporations. The same also holds for the service provision systems 14A and 14B.

For example, the processor of each service provision system creates use record data for each fiscal month. The use record data includes payment data. The payment data is created on the basis of a fee for using the service. The use fee may be determined, for example, for each service, in accordance with the length of a use period, or in accordance with a use condition of equipment. Even when the service is not actually used in a reserved use period, a user who has reserved the service is charged unless the reservation for the service has been canceled. In addition, a repayment process or a discount process may be performed, and payment data that reflects such a process may be created. For example, the manager of the operation management system 10 or the like may perform a repayment process in response to a claim from a user or a discount process based on a sales campaign or the like.

Next, use record data regarding all services used by every user belonging to each corporation is transmitted to the corporation payment system 24 (S41). The transmission is performed under control of the operation management system 10. The operation management system 10 has been informed of records of use of the service provided by each service provision system, and each service provision system transmits use record data regarding each corporation to the corporation payment system 24 in accordance with an instruction from the operation management system 10.

Next, the corporation payment system 24 makes payment for each corporation on the basis of the use record data (S42). The corporation payment system 24 calculates, for each corporation, the sum of use fees indicated by the use record data regarding all the services and charges the sum to the corporation. When the users belonging to the corporation α use the booths 16 and the service provided by the service provision system 14A, for example, use record data regarding the booths 16 and use record data regarding the service provided by the service provision system 14A are transmitted to the corporation payment system 24. The corporation payment system 24 calculates the sum of use fees indicated by the use record data regarding the booths 16 and use fees indicated by the use record data regarding the service provided by the service provision system 14A and charges the sum to the corporation α. Payment for all the services is thus collectively made for each corporation. The sum of use fees may be calculated by the operation management system 10, the reservation management system 12, or another service provision system. It is needless to say that payment may be made for each service.

After completing payment, the corporation payment system 24 transmits data regarding a result of the payment to the corporation authentication system 22. Upon receiving the result of the payment, the corporation authentication system 22 updates a status of records of use of each corporation (S43). For example, the corporation authentication system 22 associates, on the corporate user management table, information indicating that payment has been completed with a corporation for which payment has been completed.

After making the payment, the corporation payment system 24 may perform a deposit process for the manager of the operation management system 10 or the like.

As described above, when a corporate user uses a service, the corporate user is not charged, but the corporation payment system 24 charges a corporation to which the corporate user belongs.

When a service is used using a personal account, the personal payment system 20 makes payment, and when a service is used using a corporate account, the corporation payment system 24 makes payment. In doing so, a load upon a payment system is reduced compared to when the same payment system (e.g., the corporation payment system 24) makes payment for both personal users and corporations.

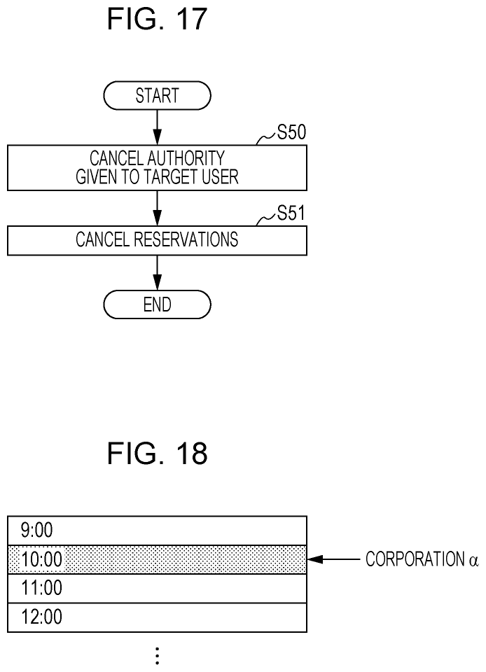

A process for withdrawing a corporate user from the operation management system 10 will be described hereinafter with reference to FIG. 17. FIG. 17 is a flowchart illustrating the process. A case where a corporate user withdraws from the operation management system 10 is an example of a case where use authority given to a corporate user is canceled.

First, the manager of the operation management system 10 or the like cancels, in accordance with a contract with a corporation or the like, use authority given to a target user (S50). For example, a manager screen is displayed on the UI 46 of the terminal apparatus 26C used by the manager or the like. The manager or the like requests, on the manager screen, cancellation of the use authority given to the target user. The terminal apparatus 26C transmits information indicating the request to the operation management system 10.

Next, the processor of each service provision system cancels, under control of the operation management system 10, all reservations for a service associated with the target user for whom the use authority has been canceled (S51). For example, the processor 42 of the reservation management system 12 cancels all reservations for the booths 16 associated with the target user for whom use authority for the booths 16 has been canceled. When use authority given to the user A having the user ID “0002” of a corporate account is canceled, for example, all reservations associated on the reservation management table with the user ID “0002” are canceled. If there is a reservation for which repayment is available, for example, information indicating that there is a reservation for which repayment is available may be transmitted to a person at the corporation, the manager of the operation management system 10, or the like by email or the like. Step S51 may be performed in a predetermined time period (e.g., at night).

The user whose use authority has been canceled is not permitted to log in to the operation management system 10 using a corporate account or reserve and use the service provided by each service provision system.

The entirety or a part of a contract may be terminated. If the entirety of a contract is terminated, for example, use authority given to all users belonging to the corporation is canceled. As partial termination of a contract, the number of users registered as corporate users having use authority may be decreased. For example, when 100 users belong to the same corporation and are registered as corporate users having use authority, the number of corporate users having use authority may be decreased. For example, the number of corporate users may be decreased to 50.

Various modifications will be described hereinafter.

Although payment for a personal user is made using registered payment means (e.g., a credit card) in the above exemplary embodiment, payment may be made using payment means other than registered payment means. For example, payment (e.g., payment with electronic money) may be made using a payment IC card or a two-dimensional code in accordance with a user's instruction, instead of a credit card. For example, the UI 46 of the terminal apparatus 26A used by a personal user who uses a booth 16 displays a button for opening an electronic lock without using a registered credit card. When an application for reserving a booth 16 is activated on the terminal apparatus 26A or the reservation management system 12 (e.g., a website) is accessed using the terminal apparatus 26A, for example, the button is displayed. The user presses the button, and the terminal apparatus 26A transmits information indicating that payment with a credit card is not performed to the personal payment system 20 through the reservation management system 12. The user holds a payment IC card onto a reading device provided for the booth 16 to complete the payment. When a display device provided for the booth 16 displays a two-dimensional code and the two-dimensional code is read by the terminal apparatus 26A, payment is completed. As the payment is completed, information indicating the completion to the personal payment system 20 through the reservation management system 12. The personal payment system 20 does not make payment for a reservation for which payment has already been completed. When the user reserves a booth 16, the user may make a setting for making payment using payment means different from registered payment means.

If payment is not completed with a payment IC card, a two-dimensional code, or the like (e.g., if the balance is not enough for a use fee), the electronic lock is not opened. If a credit card is registered as payment means in this case, the processor 42 of the reservation management system 12 may notify the user of details on payment with the credit card. For example, the processor 42 may transmit information indicating the details to the terminal apparatus 26 used by the user or display the information on the display device provided for the booth 16. If the user selects the payment with a credit card, payment is made with the credit card.

If the electronic lock of the booth 16 is not opened, payment with an IC card, a two-dimensional code, or the like is not completed, or the user does not select payment with a credit card even when a predetermined period of time has elapsed since a start (e.g., 10:00) of a reserved use period, the processor 42 of the reservation management system 12 may cancel the reservation. After the reservation is canceled, other users can reserve the use period.

The user may be able to switch between payment with a personal account and payment with a corporate account. For example, when a corporate user uses a booth 16 using a corporate account and selects payment with the personal payment system 20, for example, the processor 42 of the reservation management system 12 transmits use record data regarding the booth 16 to the personal payment system 20. In this case, the personal payment system 20, not the corporation payment system 24, makes payment for the use of the booth 16. More specifically, when the user reserves a booth 16 using a corporate account, opens an electronic lock on the booth 16, uses the booth 16, and selects payment with the personal payment system 20, the personal payment system 20 makes payment for the use of the booth 16. For example, the UI 46 of the terminal apparatus 26 used by the user displays a button for switching from payment with a corporate account to payment with a personal account while the user is using the booth 16 or after the user uses the booth 16. The user presses the button to switch from payment with a corporate account to payment with a personal account, and the terminal apparatus 26 transmits information indicating the switching to the reservation management system 12. The processor 42 of the reservation management system 12 transmits use record data to the personal payment system 20 in accordance with a request for the switching. The same holds for the service provision systems 14A and 14B.

The processor 42 of the reservation management system 12 may permit the user to change a payment system until payment is made. For example, the processor 42 permits the user to change the payment system until the personal payment system 20 makes payment after the user switches from payment with a corporate account to payment with a personal account. If the user switches from payment with a personal account to payment with a corporate account in this period, the processor 42 transmits use record data to the corporation payment system 24.

Functions available to the user in reservation of a service may be different between a personal account and a corporate account. For example, when using a corporate account, a corporate user is permitted to reserve a service reserved by a corresponding corporation (e.g., a service reserved by a representative of the corporation) as a service to be used thereby. When using a personal account, on the other hand, the corporate user is not permitted to reserve a service reserved by the corporation as a service to be used thereby.

For example, when a corporate user uses a corporate account, the processor 42 of the reservation management system 12 permits the corporate user to reserve a booth 16 reserved by a corporation as a service to be used by the corporate user. When a user uses a personal account, on the other hand, the processor 42 does not permit the user to reserve a booth 16 reserved by a corporation as a service to be used by the user.

A specific example will be described hereinafter with reference to FIG. 18. FIG. 18 illustrates use periods of a booth 16. For example, the corporation α reserves a booth 16 (e.g., a booth B) for use on a certain day (e.g., January 10) from 10:00 to 11:00. For example, the reservation is made through a contract between the corporation α and the management company of the operation management system 10 or the like. In this case, the processor 42 of the reservation management system 12 permits each corporate user belonging to the corporation α to reserve time periods including the above time period (e.g., 10:00 to 11:00). In the example illustrated in FIG. 18, the processor 42 of the reservation management system 12 permits each corporate user belonging to the corporation α to reserve time periods on January 10. Each corporate user can reserve the time periods on January 10 by accessing the reservation management system 12 using a corporate account associated with the corporation α. That is, the processor 42 of the reservation management system 12 permits a user who has logged in to the reservation management system 12 using a corporate account associated with the corporation α to reserve the time periods on January 10.

A personal user, on the other hand, cannot reserve the time periods on January 10 using a personal account. That is, the processor 42 of the reservation management system 12 does not permit a user who has logged in to the reservation management system 12 using a personal account to reserve the time periods on January 10.

In another example, types of devices available in a booth 16 may be different between a personal account and a corporate account. For example, a corporate user who has logged in to the reservation management system 12 using a corporate account may be permitted to use a high-performance air conditioner, a high-performance MFP, or the like compared to a personal user who has logged in to the reservation management system 12 using a personal account. When a locked box storing special tools or the like is provided inside a booth 16, corporate users may be permitted to unlock the box. When the box is fitted with an electronic lock, for example, a corporate user may open the electronic lock using use information associated with a corporate account.

It is possible, for example, that a booth 16 is used by a medical worker or a person who makes a contract. In the case of a medical worker, the medical worker might give patients treatment or take blood for testing. Tools for these purposes may be stored in the box, and a user who has a corporate account relating to a medical facility may be permitted to open the box by opening the electronic lock. Alternatively, a seal or the like may be stored in the box and used to make a contract.

When an error occurs in the systems, notification of the error is controlled. If an error occurs in the corporation authentication system 22 or the corporation payment system 24 when the user logs in the reservation management system 12, for example, the manager of the operation management system 10 or the like is not notified of the error by email. In this case, the user contacts the manager or the like, and the manager or the like performs a repayment process or the like. If an error occurs in the corporation authentication system 22 or the corporation payment system 24 at a time of payment, the manager of the operation management system 10 or the like is not notified of the error by email. In this case, a predetermined management process is performed. For example, manual payment or the like is made.

If an error occurs in the personal payment system 20 when the user is registered to the reservation management system 12, the manager of the operation management system 10 or the like is not notified of the error by email. In this case, the user contacts the manager or the like, and the manager or the like helps the user register himself/herself. If an error occurs in the personal payment system 20 at a time of payment, the manager of the operation management system 10 or the like is not notified of the error by email. In this case, a predetermined management process is performed. For example, manual payment or the like is made.

A process performed when the user withdraws from a service will be described in more detail.

When the user withdraws from a service, execution of a withdrawal process may be controlled in accordance with a current use condition of the service. More specifically, when a user of a service for renting out a space provided with a controllable lock withdraws from the service, execution of a withdrawal process is controlled in accordance with a current use condition of the service.

The above space is, for example, a booth 16 fitted with a controllable lock. When the user withdraws from the reservation management system 12, for example, the processor 42 of the reservation management system 12 controls execution of a withdrawal process in accordance with a current use condition of the booth 16. The same holds for the service provision systems 14A and 14B.

For example, the booth 16 is not unlocked if the user withdraws from the reservation management system 12 while using the booth 16. That is, if the user who is using the booth 16 withdraws from the reservation management system 12, the processor 42 of the reservation management system 12 sets the electronic lock and does not permit the user to open the electronic lock. As a result, if the user in the booth 16 withdraws from the reservation management system 12, the user is confined to the booth 16. If a user outside the booth 16 withdraws from the reservation management system 12, the user is shut out from the booth 16 and can no longer enter the booth 16.

While the user is using the booth 16, therefore, the processor 42 of the reservation management system 12 inhibits the user from withdrawing from the reservation management system 12. For example, the processor 42 checks whether there is a user in the booth 16 using a human detection sensor or an entry/exit management system and, if there is a user in the booth 16, inhibits the user from withdrawing from the reservation management system 12. More specifically, while a user who has reserved the booth 16 is using the booth 16, the processor 42 of the reservation management system 12 inhibits the user from withdrawing from the reservation management system 12. That is, while a user who has reserved the booth 16, opened the electronic lock, and entered the booth 16 is using the booth 16 in a reserved use period, the processor 42 inhibits the user from withdrawing from the reservation management system 12.

When the user is not using the booth 16, on the other hand, the processor 42 of the reservation management system 12 permits the user to withdraw from the reservation management system 12. That is, when the present time is not within a use period reserved by the user, the processor 42 permits the user to withdraw from the reservation management system 12. In another example, if it is confirmed that the user is not inside the booth 16 although the present time is within a use period reserved by the user, the processor 42 permits the user to withdraw from the reservation management system 12. When the user has not opened the electronic lock of the booth 16, for example, it is estimated that the user has not entered the booth 16 even in a reserved use period. The processor 42, therefore, permits the user to withdraw from the reservation management system 12.

If a human detection sensor or the like detects that there is a person in the booth 16 in a use period reserved by no one, the processor 42 of the reservation management system 12 may permit the user to withdraw from the reservation management system 12. A person in the booth 16 in a use period reserved by no one might be an intruder who is not authorized to use the booth 16. In this case, the processor 42 permits the user to withdraw from the reservation management system 12.

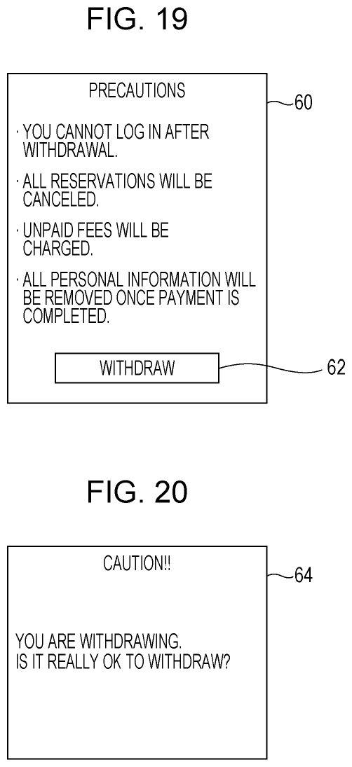

A screen for withdrawal (hereinafter referred to as a “withdrawal screen”) will be described with reference to FIG. 19. FIG. 19 illustrates an example of the withdrawal screen.

When the user logs in the reservation management system 12 using the terminal apparatus 26A and a personal account, for example, the UI 46 of the terminal apparatus 26A displays a menu screen including a withdrawal menu. If the user selects the withdrawal menu in the menu screen, the UI 46 displays a withdrawal screen 60. The withdrawal screen may include precautions.

When the user is permitted to withdraw, a withdrawal button 62 is displayed in the withdrawal screen 60, and the user can press the withdrawal button 62. If the user presses the withdrawal button 62, the terminal apparatus 26A transmits information for requesting withdrawal to the reservation management system 12, and the reservation management system 12 performs a withdrawal process. For example, the process described with reference to FIG. 11 is performed. If the withdrawal process is successfully completed, a message such as “You have successfully withdrawn” may be displayed on the UI 46 of the terminal apparatus 26A. If the withdrawal process fails, a message such as “You have failed to withdraw” may be displayed on the UI 46 of the terminal apparatus 26A. If a cancel button is displayed in the withdrawal screen 60 and the user presses the cancel button, the withdrawal screen 60 is closed.

If the user successfully withdraws, all reservations associated with an account of the user are canceled. The account is not removed until payment is completed. A removal flag, which indicates withdrawal, is associated with information regarding the user.

During the withdrawal process, the processor 42 of the reservation management system 12 may perform a process for authenticating the withdrawing user. For example, the processor 42 may transmit a personal identification number (PIN) code to an email address of the withdrawing user or authenticate the user using biological information (e.g., information regarding a fingerprint or an image of a face)

When the user is not permitted to withdraw, the withdrawal screen 60 is not displayed even if the user selects the withdrawal menu, the withdrawal screen 60 is displayed but the withdrawal button 62 is not displayed, the withdrawal button 62 is displayed but the withdrawal button 62 is disabled, or the withdrawal button 62 is enabled but the processor 42 does not accept withdrawal. For example, the withdrawal button 62 is grayed out, and the user cannot press the withdrawal button 62. The user is thus inhibited from withdrawing from the reservation management system 12.

When the user is withdrawing while using the booth 16, the processor 42 of the reservation management system 12 may output, in the booth 16, a notification indicating that the user is withdrawing. For example, the processor 42 displays information indicating the notification on the display device provided for the booth 16. Alternatively, the processor 42 may transmit the information indicating the notification to the email address of the withdrawing user or display the information indicating the notification on the UI 46 of the terminal apparatus 26 used by the withdrawing user. If the user who is using the booth 16 selects the withdrawal menu in the menu screen, the processor 42 outputs the notification. More specifically, if a user who has reserved the booth 16, opened the electronic lock in a reserved use period, entered the booth 16, and is using the booth 16 selects the withdrawal menu, the processor 42 outputs the notification. FIG. 20 illustrates an example of the notification. For example, a screen 64 is displayed on the display device provided for the booth 16 or the UI 46 of the terminal apparatus 26. For example, a message for asking the user whether it is OK to withdraw is displayed.

If information (hereinafter referred to as “confirmation information”) indicating presence or absence of the user in the booth 16 is not obtained, the processor 42 of the reservation management system 12 may inhibit the user from withdrawing. Confirmation information is, for example, information indicating a result of detection performed by a human detection sensor. For example, the processor 42 might not obtain confirmation information due to a communication error or the like. In this case, it is difficult for the processor 42 to check whether the user is inside the booth 16, and inhibits the user from withdrawing.

If a communication session relating to use of a service has stopped, the processor 42 of the reservation management system 12 may inhibit the user from withdrawing. A communication session is constructed in an information processing system and refers to, for example, a communication session between the terminal apparatus 26 and the reservation management system 12, a communication session between the personal payment system 20 and another apparatus or system, or the like. If any communication session has stopped, payment might not be completed, and the processor 42 inhibits the user from withdrawing.

If an abnormality occurs in at least either the booth 16 or the reservation management system 12, the processor 42 of the reservation management system 12 may inhibit the user from withdrawing. An abnormality is, for example, a communication error, a system error, or a system crash. If such an abnormality occurs, it is difficult to check whether the user is inside the booth 16. The processor 42, therefore, inhibits the user from withdrawing.

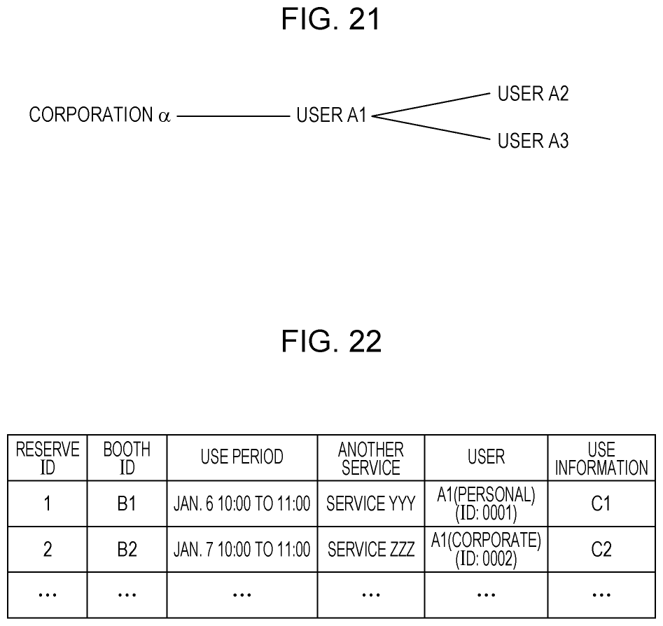

When a user belonging to a corporation is using a booth 16 using a corporate account, the processor 42 of the reservation management system 12 may inhibit the corporation from withdrawing from the reservation management system 12. This process will be described in detail hereinafter with reference to FIG. 21. FIG. 21 illustrates relationships between users belonging to the corporation.

Users A1 to A3, for example, belong to the corporation α. The user A1 (e.g., a boss) is superior to the users A2 and A3, and the users A2 and A3 (e.g., subordinates) are subordinate to the user A1. The users A2 and A3 are of the same rank. A superior corporate account is assigned to the user A1, and corporate accounts lower than for the user A1 are assigned to the users A2 and A3. The users A1 to A3 are each permitted to log in to the reservation management system 12 using the corporate account assigned thereto and reserve and use the booths 16. The user A1, who has the superior corporate account, is authorized to withdraw the corporation α from the reservation management system 12. That is, the user A1 is authorized to cancel use authority given to the users A1 to A3 and withdraw the users A1 to A3 from the reservation management system 12. For example, the user A1 is a representative of the corporation α. The users A2 and A3, who have the subordinate corporate accounts, are not authorized to withdraw the corporation α from the reservation management system 12.

When at least either the user A2 or the user A3, who has the subordinate corporate account, is using a booth 16, for example, the processor 42 of the reservation management system 12 does not permit the user A1 having the superior corporate account to withdraw the corporation α from the reservation management system 12. That is, the processor 42 inhibits the corporation α from withdrawing from the reservation management system 12. When it is confirmed that at least either the user A2 or the user A3 has reserved a booth 16 and opened an electronic lock on the booth 16 in a reserved use period, for example, or when a human detection sensor or the like detects presence of a person in the booth 16 in the use period, the processor 42 inhibits the corporation α from withdrawing from the reservation management system 12. The opening of the electronic lock is confirmed with use information transmitted to the reservation management system 12.

When withdrawal of the corporation α is permitted, for example, the UI 46 of the terminal apparatus 26 used by the user A1 displays the withdrawal screen as described with reference to FIG. 19. If the user presses the withdrawal button, a process for withdrawing the corporation α is performed. When withdrawal of the corporation α is not permitted, the withdrawal screen is not displayed, the withdrawal screen is displayed but the withdrawal button is not displayed, the withdrawal button is displayed but disabled, or the processor 42 does not accept request of withdrawal even if the user A1 presses the withdrawal button. For example, the withdrawal button is grayed out to indicate that the withdrawal button is disabled.

When a user desires to withdraw from a service, a reservation for another service used in combination with the service may be canceled. When a user withdraws from the reservation management system 12, for example, a reservation for another service reserved by the user and used in combination with a booth 16 reserved by the user is canceled. This process will be described in detail hereinafter with reference to FIG. 22.

FIG. 22 illustrates an example of the reservation management table. On the reservation management table, a reservation ID, a booth ID, information indicating a use period, information regarding a user, information indicating another service, and use information are associated with one another. The information other than the information indicating another service is the same as that registered in the reservation management table illustrated in FIG. 9.

The information indicating another service indicates a service used in combination with a reserved booth 16. The other service is one provided by the service provision system 14A or 14B and may be, for example, a service used in the booth 16, a service used at a place near the booth 16, or a service used on a way to the booth 16. Specific examples of the other service include a service for performing printing using an MFP provided in the booth 16, a nearby store, or a store on the way to the booth 16, a service for receiving meals, and a service for getting education. It is needless to say that another service may be employed as the other service.

When reserving a booth 16, for example, the user reserves another service and a use period of the other service. The user reserves the other service using a service provision system that provides the other service, and the service provision system manages the reservation. The service provision system shares information regarding the reservation with the reservation management system 12. The reservation management system 12 manages the other service reserved along with the booth 16 by associating the other service with the reservation for the booth 16 on the reservation management table. The user can use the other service in the reserved use period.

In a specific example, the user A1 having a personal account including the ID “0001” reserves the booth 16 having the booth ID “B1” and another service “service YYY” used in combination with the booth 16. A use period of the other service may be the same as or different from a use period of the booth 16.

If the user A1 withdraws from the reservation management system 12, for example, the processor 42 of the reservation management system 12 cancels the reservation for the booth 16 by the user A1 and also cancels the reservation for the other service associated with the booth 16. For example, the processor 42 outputs an instruction to cancel the reservation for the other service to a service provision system that provides the other service. Upon receiving the instruction from the processor 42, the service provision system cancels the reservation for the other service.

When the processor 42 of the reservation management system 12 receives an instruction to withdraw from the reservation management system 12, the processor 42 may transmit, to a withdrawing user, a notification indicating that the reservation for the other service will be canceled. For example, the processor 42 transmits information indicating the notification to a terminal apparatus 26 used by the withdrawing user. If the withdrawing user gives the processor 42 an instruction to cancel the reservation for the other service, the processor 42 cancels the reservation for the other service.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application-Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
transmit data regarding a record of use of a service used by a user to a different payment system in accordance with a type of account of the user.

2. The information processing apparatus according to claim 1,
wherein the account of the user is a personal account, which is an account for a personal user to use the service, or an organization account, which is an account for a user belonging to an organization to use the service.

3. The information processing apparatus according to claim 2,
wherein, if the service is used using the personal account, the processor transmits the data regarding the record of use to a first payment system, which is a system that makes payment for a person, and
wherein, if the service is used using the organization account, the processor transmits the data regarding the record of use to a second payment system that makes payment for an organization.

4. The information processing apparatus according to claim 3,
wherein the processor also creates an account for using the service through a different process in accordance with a type of user.

5. The information processing apparatus according to claim 4,
wherein, in a case where payment means of the personal user has been registered to the first payment system, the processor creates the personal account, and
wherein, in a case where the user belonging to the organization has received a notification about user registration and information regarding the user who has received the notification has been registered, the processor creates the organization account for the user who has received the notification to use the service.

6. The information processing apparatus according to claim 5,
wherein payment means different from the registered payment means makes payment in accordance with an instruction from the user.

7. The information processing apparatus according to claim 3,
wherein data regarding records of use of all services by the user belonging to the organization is transmitted to the second payment system.

8. The information processing apparatus according to claim 3,
wherein data regarding a record of use is transmitted to the first payment system for each service used by the personal user.

9. The information processing apparatus according to claim 2,
wherein a function available in reservation of a service is different between the personal account and the organization account.

10. The information processing apparatus according to claim 3,
wherein a function available in reservation of a service is different between the personal account and the organization account.

11. The information processing apparatus according to claim 4,
wherein a function available in reservation of a service is different between the personal account and the organization account.

12. The information processing apparatus according to claim 5,
wherein a function available in reservation of a service is different between the personal account and the organization account.

13. The information processing apparatus according to claim 6,
wherein a function available in reservation of a service is different between the personal account and the organization account.

14. The information processing apparatus according to claim 7,
wherein a function available in reservation of a service is different between the personal account and the organization account.

15. The information processing apparatus according to claim 8,
wherein a function available in reservation of a service is different between the personal account and the organization account.

16. The information processing apparatus according to claim 9,
wherein the user belonging to the organization is permitted, using the organization account, to reserve, as a service to be used by the user, a service reserved by the organization, and
wherein the personal user is not permitted, using the personal account, to reserve, as a service to be used by the user, a service reserved by an organization.

17. The information processing apparatus according to claim 10,
wherein the user belonging to the organization is permitted, using the organization account, to reserve, as a service to be used by the user, a service reserved by the organization, and
wherein the personal user is not permitted, using the personal account, to reserve, as a service to be used by the user, a service reserved by an organization.

18. The information processing apparatus according to claim 3,
wherein, in a case where the user belonging to the organization has used the service using the organization account and selected payment through the first payment system, the processor also transmits data regarding a record of use of the service to the first payment system.

19. The information processing apparatus according to claim 18,
wherein the processor also permits the user to switch a payment system until the first payment system makes payment.

20. A non-transitory computer readable medium storing a program causing a computer to execute a process comprising:
transmitting data regarding a record of use of a service used by a user to a different payment system in accordance with a type of account of the user.
